(19) United States
(12) Patent Application Publication
(10) Pub. No.: US 2025/0074324 A1
(43) Pub. Date: Mar. 6, 2025

(54) Truck Bed Cargo Storage and Organization Device

(71) Applicant: Rick Rogerson, Castlegar (CA)

(72) Inventor: Rick Rogerson, Castlegar (CA)

(21) Appl. No.: 18/823,039

(22) Filed: Sep. 3, 2024

Related U.S. Application Data
(60) Provisional application No. 63/580,473, filed on Sep. 5, 2023.

(51) Int. Cl. B60R 9/06; B60R 11/00; B60R 11/06

(52) U.S. Cl. CPC B60R 9/06; B60R 11/06; B60R 2011/0059

(57) ABSTRACT

A truck bed cargo storage and organization device is provided. The device is comprised of a body that can be made from various materials, including waterproof and UV-resistant, wherein the device is shaped to fit above the wheel well of a truck bed (or in any other area of the bed). The body includes at least one fastener, which can be an adjustable strap, clip, clamp, magnet, or suction cup, to suspend the body within the truck bed. The device also comprises at least one pocket for storing items, which may have various closures, such as zippers or flaps, and could include a transparent window for visibility. The method of use involves securing the device within a truck bed using the fasteners and placing items into the pockets to protect them from damage and prevent tangling during transport.

### CROSS-REFERENCE TO RELATED APPLICATION

The present application claims priority to, and the benefit of, U.S. Provisional Application No. 63/580,473, which was filed on Sep. 5, 2023, and is incorporated herein by reference in its entirety.

### FIELD OF THE INVENTION

The present invention relates generally to the field of organization devices. More specifically, the present invention relates to a truck bed cargo storage and organization device that provides a suspended location within a truck bed to easily and individually store items such as but not limited to tie-down straps, wherein the straps are protected from the elements, transport damage, and from becoming tangled with each other. Accordingly, the present disclosure makes specific reference thereto. Nonetheless, it is to be appreciated that aspects of the present invention are also equally applicable to other like applications, devices, and methods of manufacture.

### BACKGROUND

Tie-down straps, hooks, and various other security devices play a crucial role in the safe transportation of cargo across different types of vehicles, such as pickup truck beds, box trucks, vans, trailers, and other similar transport vehicles. These devices are designed to firmly secure cargo, ensuring that it remains stationary during transit, preventing it from shifting, sliding, or falling, which could otherwise lead to significant damage to the cargo itself, the vehicle, or even cause severe accidents on the road. The use of tie-down straps is especially important in maintaining safety standards, as unsecured or poorly secured cargo can become a major hazard, not only for the vehicle transporting it but also for other road users.

However, despite their importance, tie-down straps are often not stored with adequate care or organization. In many cases, these straps, along with hooks and other securing tools, are stored loosely in the truck bed or designated storage compartments. This lack of organization can lead to the straps becoming tangled, knotted, or entwined with other items, creating a frustrating and time-consuming problem when it comes time to use them. Untangling and straightening the straps can delay the loading process, increasing the time required to secure the cargo properly and potentially causing delays in delivery schedules. Furthermore, straps that are not properly stored are more likely to suffer from wear and tear, as they may be dragged across rough surfaces or exposed to sharp edges that can cause damage.

In addition to the inconvenience caused by improper storage, unprotected tie-down straps are highly susceptible to damage from environmental factors. When left exposed to the elements, such as rain, snow, sleet, hail, intense sunlight, or fluctuating temperatures, the materials of the straps-often made of synthetic fibers like nylon or polyester—can degrade over time. Prolonged exposure to moisture can lead to mold and mildew growth, which weakens the structural integrity of the straps. On the other hand, UV radiation from the sun can cause the fibers to break down and lose their strength, making them brittle and more prone to snapping. Temperature extremes, such as freezing cold or scorching heat, can also compromise the elasticity and tensile strength of the straps, further diminishing their effectiveness.

The consequences of using damaged or weakened tie-down straps can be dire. If a strap were to break while a vehicle is in motion, the secured cargo could shift, slide, or even be ejected from the vehicle. This movement could result in significant damage to the cargo itself, potentially rendering it unsellable or unfit for use, leading to financial loss. More importantly, shifting or falling cargo poses a significant safety risk to the vehicle transporting it, potentially causing loss of control or accidents. Loose cargo can also become a dangerous projectile on the road, endangering other vehicles, pedestrians, and causing accidents that could result in injury or even fatalities.

Therefore, there exists a long-felt need in the art for a storage solution for tic-down straps and other devices of the like. There also exists a long-felt need in the art for a truck bed cargo storage and organization device. More specifically, there exists a long-felt need in the art for a truck bed cargo storage and organization device that can organize and separate tic-down straps and other devices of the like. Further, there exists a long-felt need in the art for a truck bed cargo storage and organization device that can organize and separate tie-down straps and other devices of the like, wherein the device prevents said items from weather damage and from becoming damaged from moving within the truck bed or vehicle.

The subject matter disclosed and claimed herein, in one embodiment thereof, comprises a truck bed cargo storage and organization device. The device is comprised of a body that can be made from various materials, including waterproof and UV-resistant, wherein the device is shaped to fit above the wheel well of a truck bed (or in any other area of the bed). The body includes at least one fastener, which can be an adjustable strap, clip, clamp, magnet, or suction cup, to suspend the body within the truck bed. The device also comprises at least one pocket for storing items, which may have various closures, such as zippers or flaps, and could include a transparent window for visibility. The method of use involves securing the device within a truck bed using the fasteners and placing items into the pockets to protect them from damage and prevent tangling during transport.

In this manner, the truck bed cargo storage and organization device of the present invention accomplishes all the forgoing objectives and provides a storage solution for tie-down straps and other devices of the like, wherein the device organizes and separates tie-down straps and other devices of the like. Further, the device protects said items from weather damage and from becoming damaged from moving within the truck bed or vehicle.

### SUMMARY

The following presents a simplified summary to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a truck bed cargo storage and organization device. The device is comprised of a body shaped such that it fits above the wheel well when positioned in the bed of a pickup truck on an interior side of the bed. However, the device may be positioned anywhere within a truck bed body (or other vehicle area). The body is preferably made from a waterproof fabric material that may also be UV-resistant to protect items stored inside the device against weather damage. The body may also be made from a tear-resistant material to prevent items placed within the device from ripping/puncturing the body or any portion thereof.

The body is comprised of at least one fastener. In one embodiment, the fastener is integrally formed within and is inseparable from the body. In a different embodiment, the fastener is removably placed through at least one opening of the body. In one embodiment, the fastener may be an adjustable strap with at least one hook on each end, wherein the strap may be adjustable in length. As a result, each end of the fastener can be used to suspend the body within a truck bed (preferably over the wheel well or other location) via placing each hook into pre-existing box holes within a truck bed.

The body is also comprised of at least one pocket. In one embodiment, the body is comprised of a plurality of pockets, wherein each pocket is separated by at least one double stitch for reinforcement and support. The pocket is comprised of at least one opening. The pocket may be used to store various items, tools, equipment, etc. such as but not limited to straps, hooks, ties, etc. In one embodiment, the pocket is an open-top pocket. In another embodiment, the pocket may be comprised of a fastener that allows the opening to be closed.

The present invention is also comprised of a method of using the device. First, a device is provided comprised of a body comprised of at least one pocket and at least one fastener preferably comprised of at least two hooks. Then, a first hook can be placed in a first box-hole opening of a truck bed and the second hook can be placed in a second box-hole opening of a truck bed to suspend the body within the truck bed via the fastener. Next, a user can place an item into the pocket such that the pocket protects the item from weather/movement damage and also prevents the item from tangling.

Accordingly, the truck bed cargo storage and organization device of the present invention is particularly advantageous as it provides a storage solution for tie-down straps and other devices of the like, wherein the device organizes and separates tie-down straps and other devices of the like. Further, the device protects said items from weather damage and from becoming damaged from moving within the truck bed or vehicle. In this manner, the truck bed cargo storage and organization device overcomes the limitations of existing methods used to store tie-down straps and similar items with a truck bed.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a front view of one potential embodiment of a truck bed cargo storage and organization device of the present invention in accordance with the disclosed architecture; and

FIG. 2 illustrates a flowchart of a method of using one potential embodiment of a truck bed cargo storage and organization device of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth to provide a thorough understanding thereof. It may be evident, however, that the innovation can be practiced without these specific details. In other instances, well-known structures and devices are shown in block diagram form to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for a storage solution for tie-down straps and other devices of the like. There also exists a long-felt need in the art for a truck bed cargo storage and organization device. More specifically, there exists a long-felt need in the art for a truck bed cargo storage and organization device that can organize and separate tie-down straps and other devices of the like. Further, there exists a long-felt need in the art for a truck bed cargo storage and organization device that can organize and separate tie-down straps and other devices of the like, wherein the device prevents said items from weather damage and from becoming damaged from moving within the truck bed or vehicle.

The present invention, in one exemplary embodiment, is comprised of a truck bed cargo storage and organization device comprised of a body shaped such that it fits above the wheel well when positioned in the bed of a pickup truck on an interior side of the bed. However, the device may be positioned anywhere within a truck bed body (or other vehicle area). The body is preferably made from a waterproof fabric material that may also be UV-resistant to protect items stored inside the device against weather damage. The body may also be made from a tear-resistant material to prevent items placed within the device from ripping/puncturing the body or any portion thereof.

The body is comprised of at least one fastener. The fastener may be integrally formed within and is inseparable from the body. In a different embodiment, the fastener is removably placed through at least one opening of the body. In one embodiment, the fastener may be an adjustable strap with at least one hook on each end, wherein the strap may be adjustable in length and wherein each end of the fastener can be used to suspend the body within a truck bed (preferably over the wheel well or other location) via placing each hook into pre-existing box holes within a truck bed.

The body is also comprised of at least one pocket. In one embodiment, the body is comprised of a plurality of pockets, wherein each pocket is separated by at least one double stitch for reinforcement and support. The pocket is comprised of at least one opening. The pocket may be used to store various items, tools, equipment, etc. such as but not limited to straps, hooks, ties, etc. In one embodiment, the pocket is an open-top pocket. In another embodiment, the pocket may be comprised of a fastener that allows the opening to be closed.

The present invention is also comprised of a method of using the device. First, a device is provided comprised of a body comprised of at least one pocket and at least one fastener preferably comprised of at least two hooks. Then, a first hook can be placed in a first box-hole opening of a truck bed and the second hook can be placed in a second box-hole opening of a truck bed to suspend the body within the truck bed via the fastener. Next, a user can place an item into the pocket such that the pocket protects the item from weather/movement damage and also prevents the item from tangling.

Accordingly, the truck bed cargo storage and organization device of the present invention is particularly advantageous as it provides a storage solution for tie-down straps and other devices of the like, wherein the device organizes and separates tic-down straps and other devices of the like. Further, the device protects said items from weather damage and from becoming damaged from moving within the truck bed or vehicle. In this manner, the truck bed cargo storage and organization device overcomes the limitations of existing methods used to store tie-down straps and similar items with a truck bed.

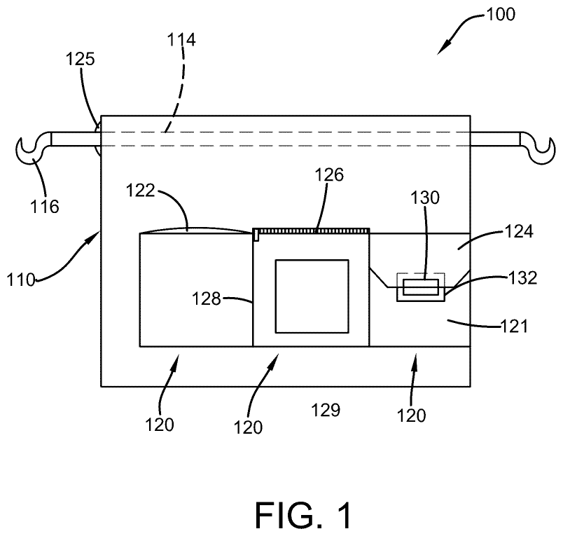

Referring initially to the drawings, FIG. 1 illustrates a front view of one potential embodiment of a truck bed cargo storage and organization device 100 of the present invention in accordance with the disclosed architecture. The device 100 is comprised of a body 110. The body 110 may be any shape but is preferably rectangular such that it fits above the wheel well when positioned in the bed of a pickup truck on an interior side of the bed. However, the device 100 may be positioned anywhere within a truck bed body (or other vehicle area).

The body 110 is preferably made from a waterproof fabric material that may also be UV-resistant to protect items stored inside the device 100 against weather damage. The body 110 may also be made from a tear-resistant material to prevent items placed within the device 100 from ripping/puncturing the body 110 or any portion thereof. In one embodiment, the body 110 (or some portion of the body 110) may be made from a rigid material such as but not limited to a UV-resistant plastic.

The body 110 is comprised of at least one fastener 114. In one embodiment, the fastener 114 is integrally formed within and is inseparable from the body 110. In a different embodiment, the fastener 114 is removably placed through at least one opening 112 of the body 110. The opening 112 may be a reinforced opening for strength. In one embodiment, the fastener 114 may be an adjustable strap, adjustable ratchet strap, retractable ratchet strap, etc. This includes but is not limited to a ratchet strap or any strap with at least one hook 116 on each end, wherein the strap may be adjustable in length. As a result, each end of the fastener 114 can be used to suspend the body 110 within a truck bed (preferably over the wheel well or other location) via placing each hook 16 into pre-existing box holes within a truck bed. In another embodiment, the fastener 114 may be a different fastener type such as but not limited to a clip, a clamp, a magnet, a suction cup, etc. that allows the body 110 to be suspended from the interior of a truck bed by attached to the bed and/or other area of the truck. Because the fastener 114 is easily removable from a truck bed, the device 100 can be easily moved as needed (even taken out of the truck bed) and suspended from various other locations outside of a vehicle.

The body 110 is also comprised of at least one pocket 120. In one embodiment, the body 110 is comprised of a plurality of pockets 120, wherein each pocket 120 is separated by at least one double stitch 128 for reinforcement and support. The pocket 120 is comprised of at least one opening 122. The pocket 120 may be used to store various items, tools, equipment, etc. such as but not limited to straps, hooks, ties, etc. In one embodiment, the pocket 120 is an open-top pocket. In another embodiment, the pocket 120 may be comprised of a fastener 126 that allows the opening 122 to be closed. In this embodiment, the fastener 126 may include but is not limited to a zipper, a waterproof zipper, a snap button, a magnet, a hook and loop fastener, etc. In a different embodiment, the opening 122 can be covered by at least one flap 124. The flap 124 may attach to an exterior surface 121 of the pocket 120 via at least one fastener 130 of the flap 124 that engages at least one fastener 132 positioned on the exterior surface 121. The fasteners 130, 132 may be any type of reciprocating fasteners such as but not limited to a hook fastener and a loop fastener, a male fastener and a female fastener, a snap button fastener, a magnet fastener, a button and opening fastener, etc. In one embodiment, the pocket 120 may be comprised of at least one transparent viewing window 129 (and/or a transparent material) to allow a user to easily see the contents of the pocket 120. In one embodiment, the entire body 110 may be covered by at least one waterproof flap 124 that attaches to the body 110 in the same manner as it would attach to an embodiment as described above. The flap 124 covers all pockets 120 to ensure water does not penetrate the pockets 120 and saturate any items stored within the same.

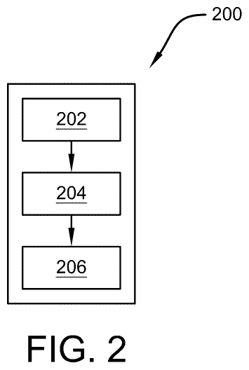

The present invention is also comprised of a method of using 200 the device 100, as seen in FIG. 2. First, a device 100 is provided comprised of a body 110 comprised of at least one pocket 120 and at least one fastener 114 preferably comprised of at least two hooks 116 [Step 202]. Then, a first hook 116 can be placed in a first box-hole opening of a truck bed and the second hook 116 can be placed in a second box-hole opening of a truck bed to suspend the body 110 within the truck bed via the fastener 114 [Step 204]. Next, a user can place an item into the pocket 120 such that the pocket 120 protects the item from weather/movement damage and also prevents the item from tangling [Step 206].

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “truck bed cargo storage and organization device” and “device” are interchangeable and refer to the truck bed cargo storage and organization device 100 of the present invention.

Notwithstanding the forgoing, the truck bed cargo storage and organization device 100 of the present invention and its various components can be of any suitable size and configuration as is known in the art without affecting the overall concept of the invention, provided that they accomplish the above-stated objectives. One of ordinary skill in the art will appreciate that the size, configuration, and material of the truck bed cargo storage and organization device 100 as shown in the FIGS. are for illustrative purposes only, and that many other sizes and shapes of the truck bed cargo storage and organization device 100 are well within the scope of the present disclosure. Although the dimensions of the truck bed cargo storage and organization device 100 are important design parameters for user convenience, the truck bed cargo storage and organization device 100 may be of any size, shape, and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A truck bed cargo storage and organization device comprising:
a body comprised of:
an opening;
a fastener that passes through the opening; and
a pocket.

2. The truck bed cargo storage and organization device of claim 1, wherein the body is comprised of a waterproof fabric.

3. The truck bed cargo storage and organization device of claim 1, wherein the fastener is comprised of a ratchet strap.

4. The truck bed cargo storage and organization device of claim 3, wherein the fastener is comprised of a first hook and a second hook.

5. The truck bed cargo storage and organization device of claim 1, wherein the body is comprised of a UV-resistant material.

6. The truck bed cargo storage and organization device of claim 1, wherein the pocket is comprised of a transparent material.

7. A truck bed cargo storage and organization device comprising:
a body comprised of:
an opening;
a first fastener fixedly attached to the body; and
a pocket comprised of an opening.

8. The truck bed cargo storage and organization device of claim 7, wherein the pocket is comprised of a second fastener is comprised of a zipper, a waterproof zipper, a snap button, a magnet, or a hook and loop fastener.

9. The truck bed cargo storage and organization device of claim 7, wherein the pocket is comprised of a third fastener positioned on an exterior surface of the pocket.

10. The truck bed cargo storage and organization device of claim 9, wherein the third fastener is comprised of a hook fastener, a loop fastener, a female fastener, a male fastener, a snap fastener, a button fastener, a magnet fastener, a button fastener, or an opening fastener.

11. The truck bed cargo storage and organization device of claim 9, wherein the pocket is comprised of a flap comprised of a fourth fastener.

12. The truck bed cargo storage and organization device of claim 11, wherein the fourth fastener is comprised of a hook fastener, a loop fastener, a female fastener, a male fastener, a snap fastener, a button fastener, a magnet fastener, a button fastener, or an opening fastener.

13. The truck bed cargo storage and organization device of claim 7, wherein the pocket is comprised of a transparent viewing window.

14. The truck bed cargo storage and organization device of claim 7, wherein the pocket is comprised of a reinforced stitch.

15. The truck bed cargo storage and organization device of claim 7, wherein the first fastener is comprised of a strap.

16. The truck bed cargo storage and organization device of claim 15, wherein the strap is comprised of a first hook and a second hook.

17. The truck bed cargo storage and organization device of claim 15, wherein the strap is comprised of an adjustable length strap.

18. The truck bed cargo storage and organization device of claim 7, wherein the first fastener is comprised of a clip, a clamp, a magnet, or a suction cup.

19. A method of using a truck bed cargo storage and organization device, the method comprising the following steps:
providing a truck bed cargo storage and organization device comprised of a body comprised of a pocket and a fastener comprised of a first hook and a second hook;
placing the first hook in a first box-hole opening of a truck bed;
placing the second hook in a second box-hole opening of the truck bed such that the body is suspended within the truck bed via the fastener; and
placing an item into the pocket such that the pocket protects the item from weather damage, movement damage, and tangling.

20. The method of using a truck bed cargo storage and organization device of claim 19, wherein the body is comprised of a waterproof fabric material.
